(19) United States
(12) Patent Application Publication
(10) Pub. No.: US 2023/0016507 A1
(43) Pub. Date: Jan. 19, 2023

(54) COMPUTER-READABLE RECORDING MEDIUM STORING CONTROL PROGRAM AND CONTROL METHOD

(71) Applicant: FUJITSU LIMITED, Kawasaki-shi (JP)

(72) Inventor: Hiroyoshi Kodama, Isehara (JP)

(73) Assignee: FUJITSU LIMITED, Kawasaki-shi (JP)

(21) Appl. No.: 17/719,777

(22) Filed: Apr. 13, 2022

(30) Foreign Application Priority Data
Jul. 15, 2021 (JP) 2021-117014

(51) Int. Cl. G06F 1/26; H02J 9/06

(52) U.S. Cl. CPC G06F 1/263; H02J 9/068; H02J 9/062

(57) ABSTRACT

A computer-readable recording medium storing a control program for causing a computer to execute a process, the process includes detecting, at predetermined time intervals, an average value of power detected from each breaker of breaker groups in a plurality of hierarchical levels to which power is supplied from a plurality of power supplies, and causing, in a case where there is a breaker of which the average value has an increase by a predetermined ratio or more in a certain hierarchical level and an upper hierarchical level of the certain hierarchical level among the plurality of hierarchical levels, one power supply among the plurality of power supplies to output power obtained by adding the increase in the breaker in the upper hierarchical level.

### CROSS-REFERENCE TO RELATED APPLICATION

This application is based upon and claims the benefit of priority of the prior Japanese Patent Application No. 2021-117014, filed on Jul. 15, 2021, the entire contents of which are incorporated herein by reference.

### FIELD

The embodiment discussed herein is related to a computer-readable recording medium storing a control program and a control method.

### BACKGROUND

In the related art, in a facility that consumes a large amount of power such as a data center, various measures have been made so that the power consumption does not exceed contract demand determined by a contract with an electric power company. As one of such measures, there is known a technique in which a non-commercial power supply such as a generator is provided and a shortfall is supplied from the non-commercial power supply when the power consumption exceeds the power supplied from a commercial power supply.

Japanese Laid-open Patent Publication No. 2016-007095 is disclosed as related art.

### SUMMARY

According to an aspect of the embodiments, a computer-readable recording medium storing a control program for causing a computer to execute a process, the process includes detecting, at predetermined time intervals, an average value of power detected from each breaker of breaker groups in a plurality of hierarchical levels to which power is supplied from a plurality of power supplies, and causing, in a case where there is a breaker of which the average value has an increase by a predetermined ratio or more in a certain hierarchical level and an upper hierarchical level of the certain hierarchical level among the plurality of hierarchical levels, one power supply among the plurality of power supplies to output power obtained by adding the increase in the breaker in the upper hierarchical level.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing an outline of operations of a power control apparatus;

FIG. 2 is a diagram illustrating an example of a hardware configuration of the power control apparatus;

FIG. 3 is a diagram describing a functional configuration of the power control apparatus;

FIG. 4 is a diagram describing setting of a threshold;

FIG. 5 is a diagram describing estimation of power consumption and scales of a commercial power supply and a non-commercial power supply;

FIG. 6A is a first flowchart describing a process of the power control apparatus;

FIG. 6B is a second flowchart describing the process of the power control apparatus;

FIGS. 7A to 7C are diagrams describing a process of the power control apparatus; and

FIG. 8 is a diagram describing an effect of a present embodiment.

### DESCRIPTION OF EMBODIMENTS

In the related art in which a shortfall is supplied from a non-commercial power supply when the power consumption exceeds the power supplied from a commercial power supply, it is difficult to cause an increase in supply of the power from the non-commercial power supply and a decrease in supply of the power from the commercial power supply to occur in association with each other, and thus the power consumption may still exceed contract demand.

Hereinafter, an embodiment of a technique for keeping the power consumption from exceeding the contract demand will be described with reference to the drawings. First, an outline of the present embodiment will be described.

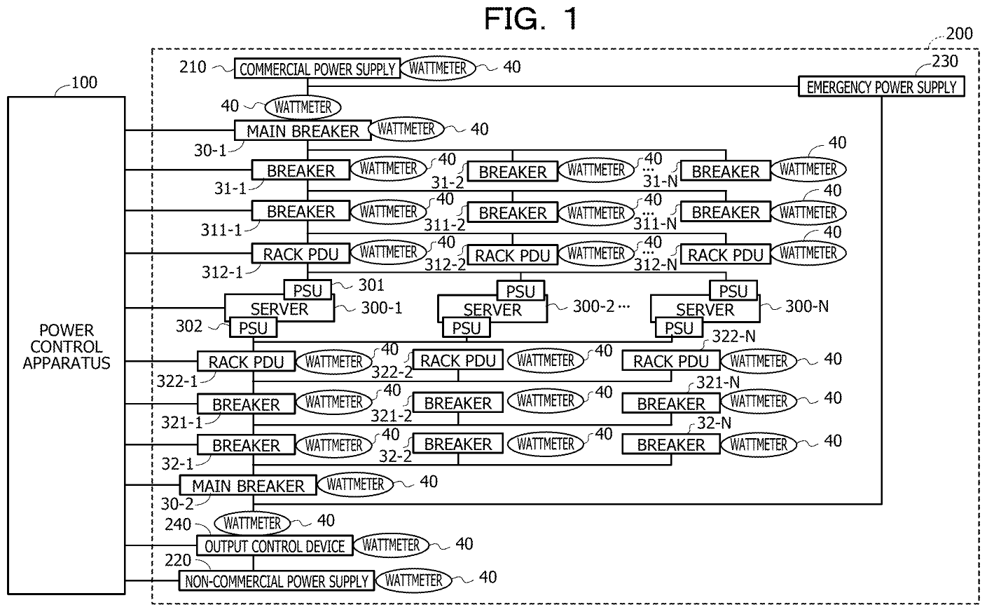

FIG. 1 is a diagram describing an outline of operations of a power control apparatus. A power control apparatus 100 of the present embodiment controls a way of supplying power in a facility in which a large number of servers are arranged, such as a data center, for example. Hereinafter, a data center 200 will be described as an example of a facility in which a large number of servers 300 are arranged.

The data center 200 includes a commercial power supply 210, a non-commercial power supply 220, an emergency power supply 230, and an output control device 240.

The data center 200 includes a main breaker 30-1 and a main breaker 30-2. The main breaker 30-1 receives supply of power from the commercial power supply 210, and distributes the power to a breaker group 31 in the next hierarchical level coupled to the main breaker 30-1. The main breaker 30-2 receives supply of power from the non-commercial power supply 220, and distributes the power to a breaker group 32 in the next hierarchical level coupled to the main breaker 30-2.

The breaker group 31 includes breakers 31-1, 31-2, . . . , and 31-N, and each of the breakers is coupled to the main breaker 30-1. For example, the breaker group 31 is a plurality of breakers coupled to the main breaker 30-1. Each of the breakers 31-1, 31-2, . . . , and 31-N distributes power to a breaker group 311 in the next hierarchical level coupled to the breaker itself.

The breaker group 311 includes breakers 311-1, 311-2, . . . , and 311-N, and each of the breakers is coupled to the breaker 31-1. For example, the breaker group 311 is a plurality of breakers coupled to the breaker 31-1. The breaker 311-1 distributes power to a rack power distribution unit (PDU) group 312 in the next hierarchical level coupled to the breaker itself.

Although not illustrated, a rack PDU group in the next hierarchical level is coupled to each of the breakers 311-2, . . . , and 311-N included in the breaker group 311.

The rack PDU group 312 includes rack PDUs 312-1, 312-2, . . . , and 312-N, and each of the rack PDUs is coupled to the breaker 311-1. The rack PDUs 312-1, 312-2, . . . , and 312-N of the present embodiment are power taps provided in a server rack for installing the servers 300 in a stacked manner.

The servers 300-1, 300-2, . . . , and 300-N are coupled to the rack PDU 312-1.

Each of the servers 300-1, 300-2, . . . , and 300-N includes Power Supply Units (PSUs) 301 and 302. The PSUs 301 and 302 are power supply devices included in the server 300. The PSU 301 receives power from the commercial power supply, and the PSU 302 receives power from the non-commercial power supply.

The PSU 301 of each of the servers 300-1, 300-2, . . . , and 300-N of the present embodiment is coupled to the rack PDU 312-1, and is supplied with power from the commercial power supply 210.

Although not illustrated, each of the rack PDUs 312-2, . . . , and 312-N included in the rack PDU group 312 is coupled to a server group, and power from the commercial power supply 210 is supplied from the corresponding rack PDU 312 to the PSU 301 of each server included in the server group.

The breaker group 32 in the next hierarchical level coupled to the main breaker 30-2 includes breakers 32-1, 32-2, . . . , and 32-N, and each of the breakers is coupled to the main breaker 30-2. For example, the breaker group 32 is a plurality of breakers coupled to the main breaker 30-2. Each of the breakers 32-1, 32-2, . . . , and 32-N distributes power to a breaker group 321 in the next hierarchical level coupled to the breaker itself.

The breaker group 321 includes breakers 321-1, 321-2, . . . , and 321-N, and each of the breakers is coupled to the breaker 32-1. For example, the breaker group 321 is a plurality of breakers coupled to the breaker 32-1. The breaker 321-1 distributes power to a rack power distribution unit (PDU) group 322 in the next hierarchical level coupled to the breaker itself.

Although not illustrated, a rack PDU group in the next hierarchical level is coupled to each of the breakers 321-2, . . . , and 321-N included in the breaker group 321.

The rack PDU group 322 includes rack PDUs 322-1, 322-2, . . . , and 322-N, and each of the rack PDUs is coupled to the breaker 321-1. The rack PDUs 322-1, 322-2, . . . , and 322-N of the present embodiment are power taps provided in a server rack for installing the servers 300 in a stacked manner.

The servers 300-1, 300-2, . . . , and 300-N are coupled to the rack PDU 322-1.

Each of the servers 300-1, 300-2, . . . , and 300-N includes the Power Supply Units (PSUs) 301 and 302. The PSUs 301 and 302 are power supply devices included in the server 300. The PSU 301 receives power from the commercial power supply, and the PSU 302 receives power from the non-commercial power supply.

The PSU 302 of each of the servers 300-1, 300-2, . . . , and 300-N of the present embodiment is coupled to the rack PDU 322-1, and is supplied with power from the non-commercial power supply 220.

Although not illustrated, each of the rack PDUs 322-2, . . . , and 322-N included in the rack PDU group 322 is coupled to a server group, and power from the non-commercial power supply 220 is supplied from the corresponding rack PDU 322 to the PSU 302 of each server included in the server group.

As described above, the server 300 of the present embodiment is supplied with power from both the commercial power supply 210 and the non-commercial power supply 220 via the breakers in a plurality of hierarchical levels.

In the data center 200 of the present embodiment, the emergency power supply 230 is, for example, an emergency power supply in a case where supply of power from the commercial power supply 210 and the non-commercial power supply 220 is stopped.

The output control device 240 controls the output power from the non-commercial power supply 220 in accordance with an instruction from the power control apparatus 100.

All the breakers and the rack PDUs included in the data center 200 of the present embodiment are individually provided with a wattmeter 40, and the wattmeter 40 measures power supplied to each breaker. In the present embodiment, the commercial power supply 210, the non-commercial power supply 220, and the output control device 240 are also provided with the wattmeter 40, and the wattmeter 40 detects the power output from each of the commercial power supply 210, the non-commercial power supply 220, and the output control device 240.

In the present embodiment, when power is supplied to the servers 300, the power consumption of the data center 200 is predicted while a usage amount of power supplied from the commercial power supply is observed in units of breakers. In a case where the power supplied from the commercial power supply 210 is insufficient for the power consumption, the power control apparatus 100 causes the shortfall to be supplied from the non-commercial power supply 220.

In the present embodiment, by monitoring power in units of breakers in this manner, it is possible to supply power corresponding to fluctuations in the operation cycle of the servers, and it is possible to keep the power to be supplied from the commercial power supply 210 from exceeding the contract demand.

In the data center 200 illustrated in FIG. 1, the main breakers 30-1 and 30-2 are breakers in the first hierarchical level which is the uppermost hierarchical level (first hierarchical level breakers) among the breakers consisting the plurality of hierarchical levels.

The breaker groups 31 and 32 are breaker groups in the second hierarchical level (second hierarchical level breakers) coupled to the respective main breakers in the first hierarchical level. Each of the breaker groups 31 and 32 includes eight breakers in the data center 200 of the present embodiment.

In the data center 200, the breaker groups 311 and 321 are coupled to each of the eight breakers included in the breaker groups 31 and 32, respectively. The breaker groups 311 and 321 are the breaker groups in the third hierarchical level (third hierarchical level breakers) coupled to the breaker in the second hierarchical level.

Each of the breaker groups 311 and 321 includes fourteen breakers in the data center 200 of the present embodiment.

In the data center 200, 20 rack PDU groups 312 and 322 are coupled to each of the fourteen breakers included in each of the breaker groups 311 and 321. For example, a rack PDU including 20 power outlets provided in a rack is coupled to each of the fourteen breakers included in each of the breaker groups 311 and 321.

Each of the rack PDU groups 312 and 322 of the present embodiment may include a breaker therein. Accordingly, the rack PDU groups 312 and 322 are breaker groups in the fourth hierarchical level (fourth hierarchical level breakers) coupled to the breaker in the third hierarchical level. Twenty servers 300 are coupled to each of the rack PDU groups 312 and 322.

Accordingly, the number of servers 300 included in the data center 200 of the present embodiment is 2×8×14×20, which is 4480. These 4480 servers 300 are supplied with power from each of the commercial power supply 210 and the non-commercial power supply 220.

The data center 200 illustrated in FIG. 1 is an example, and the number of breakers and the number of servers are not limited to this.

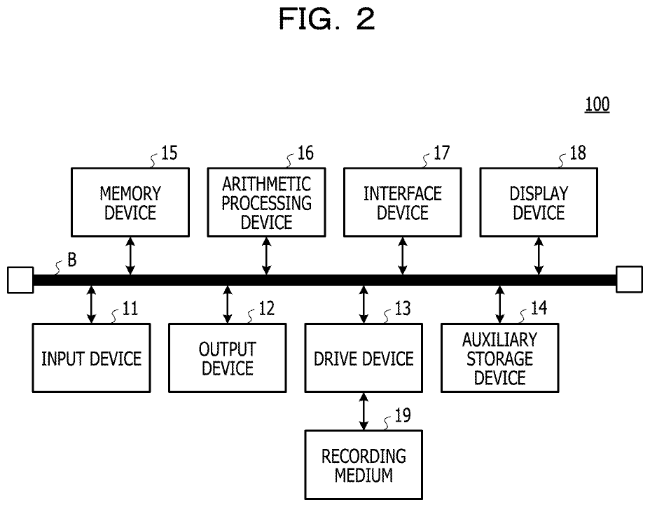

Hereinafter, the power control apparatus 100 of the present embodiment will be described. FIG. 2 is a diagram illustrating an example of a hardware configuration of the power control apparatus.

The power control apparatus 100 of the present embodiment is a computer including an input device 11, an output device 12, a drive device 13, an auxiliary storage device 14, a memory device 15, an arithmetic processing device 16, an interface device 17, and a display device 18, which are coupled to each other via a bus B.

The input device 11 is a device used for inputting various kinds of information, and is realized by, for example, a keyboard, a pointing device, or the like. The output device 12 is for outputting various kinds of information, and is realized by, for example, a display or the like. The interface device 17 includes a local area network (LAN) card or the like, and is used for coupling to a network.

A power control program included in the power control apparatus 100 is at least part of various programs for controlling the power control apparatus 100. For example, the power control program is provided through distribution of a recording medium 19, download from the network, or the like. As the recording medium 19 on which the power control program is recorded, various types of recording medium such as a recording medium on which information is optically, electrically, or magnetically recorded, for example, a compact disc read-only memory (CD-ROM), a flexible disk, or a magneto-optical disc, and a semiconductor memory or the like in which information is electrically recorded, for example, a ROM or a flash memory may be used.

When the recording medium 19 on which the power control program is recorded is set in the drive device 13, the power control program recorded on the recording medium 19 is installed in the auxiliary storage device 14 from the recording medium 19 via the drive device 13. The power control program downloaded from the network is installed in the auxiliary storage device 14 via the interface device 17.

The auxiliary storage device 14 stores the power control program installed in the power control apparatus 100, and stores various files, data, and the like to be used by the power control apparatus 100. The memory device 15 reads the power control program from the auxiliary storage device 14 in response to the activation of the power control apparatus 100, and stores therein the read power control program. The arithmetic processing device 16 implements various processes to be described later in accordance with the power control program stored in the memory device 15.

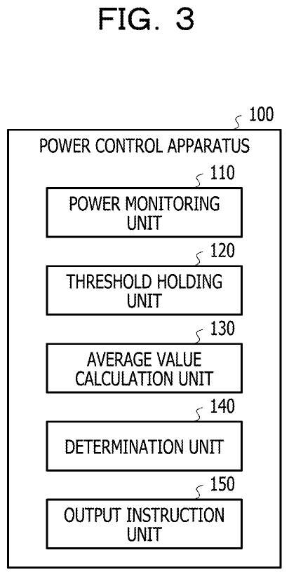

Next, a functional configuration of the power control apparatus 100 of the present embodiment will be described with reference to FIG. 3. FIG. 3 is a diagram describing a functional configuration of the power control apparatus.

The power control apparatus 100 of the present embodiment includes a power monitoring unit 110, a threshold holding unit 120, an average value calculation unit 130, a determination unit 140, and an output instruction unit 150.

The power monitoring unit 110 monitors a value detected by the wattmeter 40 provided in each of the breakers and rack PDUs of the data center 200. For example, the power monitoring unit 110 acquires a power value output from each wattmeter 40.

A value set as an upper limit value of the value detected by the wattmeter 40 provided in the main breaker 30-1 is stored in the threshold holding unit 120. The setting of the upper limit value will be described later in detail.

The average value calculation unit 130 calculates an average value of the power values acquired by the power monitoring unit 110 for a predetermined time (predetermined period). According to the average value calculated by the average value calculation unit 130, the determination unit 140 determines whether to change the power output from the non-commercial power supply 220.

According to the determination result of the determination unit 140, the output instruction unit 150 outputs an instruction signal for controlling the power output from the non-commercial power supply 220, to the output control device 240.

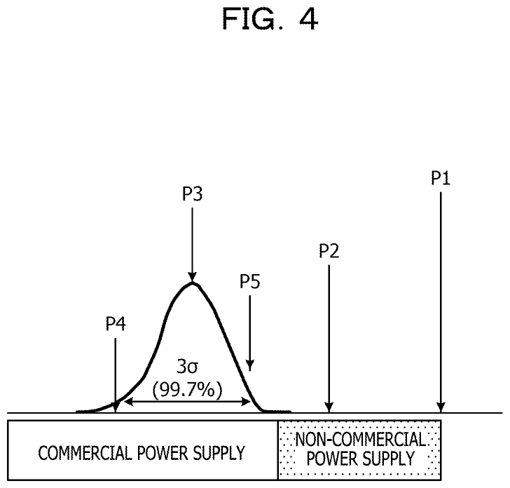

Hereinafter, the threshold held in the threshold holding unit 120 of the present embodiment will be described with reference to FIG. 4. FIG. 4 is a diagram describing the setting of the threshold.

In the present embodiment, the power consumption of the data center 200 and the scales of the commercial power supply 210 and the non-commercial power supply 220 are estimated from the number, specifications, and the like of the servers 300 constituting the data center 200, and the upper limit value of power to be supplied from the commercial power supply 210 to the first hierarchical level breaker is set in advance. For example, in the present embodiment, the upper limit value of the power to be supplied from the commercial power supply 210 is set in advance.

In the present embodiment, the maximum output power of the non-commercial power supply 220 may be determined from the estimated power consumption of the server 300.

The estimation of the power consumption of the data center 200 and the scales of the commercial power supply 210 and the non-commercial power supply 220, and the setting or the like of the upper limit value of the power to be supplied from the commercial power supply 210 are performed by an administrator or the like of the data center 200, for example.

FIG. 4 is a diagram illustrating an example of distribution of the power consumption of the server 300. For example, information indicating a power distribution of the server 300 may be provided as a result of trial calculation from a maker or the like that manufactures a central processing unit (CPU) of the server 300. The power distribution of the server 300 is assumed to be a normal distribution.

In the example illustrated in FIG. 4, a power P1 is rated maximum power consumption of the server 300, and a power P2 is the maximum power consumption when the server 300 is actually operated (actual maximum power consumption). A power P3 is power consumption (average power consumption) that is the median of the power distribution. The server 300 of the present embodiment has a CPU operation rate of about 30% in most cases, and the average power consumption is power consumption when the server 300 is operated at the CPU operation rate of about 30%.

A power P4 is power consumption during the standby of the server 300. A power P5 is power consumption with the median P3+3σ, in the power distribution illustrated in FIG. 4.

In the present embodiment, the information indicating such a distribution of the power consumption of the server 300 is grasped in advance, and based on this distribution, the upper limit value of the power to be supplied from the commercial power supply 210 to the first hierarchical level breaker and the maximum output power of the non-commercial power supply 220 are determined and held in the threshold holding unit 120.

For example, in the data center 200 of the present embodiment, the power to be supplied from the commercial power supply 210 may be set to a value corresponding to the power P5 indicating the median P3+3σ. For example, in the present embodiment, the upper limit value (threshold) of the power to be supplied to the main breaker 30-1 may be set to a value corresponding to the power P5 indicating the median P3+3σ.

In the present embodiment, the upper limit value of the power to be supplied from the commercial power supply 210 may be set to a value obtained by multiplying the power P3, which is the average power consumption, by 1.2 times.

In the present embodiment, in this manner, the upper limit value of the power to be supplied from the commercial power supply 210 is set. Based on the power detected by each breaker, the power control apparatus 100 of the present embodiment predicts fluctuations in power consumption of the data center 200, and controls the supply of the power from the non-commercial power supply 220 in accordance with the fluctuations so that the power supplied from the commercial power supply 210 does not exceed the upper limit value.

For example, in a case where there is a breaker of which the average value of the detected power at predetermined time intervals has increased by a predetermined ratio or more in the data center 200 and where the power detected from the breaker in the upper hierarchical level of the breaker has also increased by a predetermined ratio, the power control apparatus 100 predicts that the power consumption of the data center 200 is increasing. The power control apparatus 100 causes the non-commercial power supply 220 to supply power to which an increase in power in the upper hierarchical level is added.

For example, when there are breakers of which the average value of the power has increased by the predetermined ratio or more in a certain hierarchical level and an upper hierarchical level of the certain hierarchical level among the breaker groups included in the data center 200, the power control apparatus 100 causes one power supply to output power corresponding to the increase in the breaker in the upper hierarchical level.

For this reason, in the present embodiment, it is possible to increase the power supplied from the non-commercial power supply 220 before the power supplied from the commercial power supply 210 to the first hierarchical level breaker is affected by the fluctuations in the power consumption of the data center 200. Accordingly, according to the present embodiment, even in a case where the power consumption of the data center 200 has increased, it is possible to keep the power supplied from the commercial power supply 210 from exceeding the contract demand without exceeding the set upper limit value.

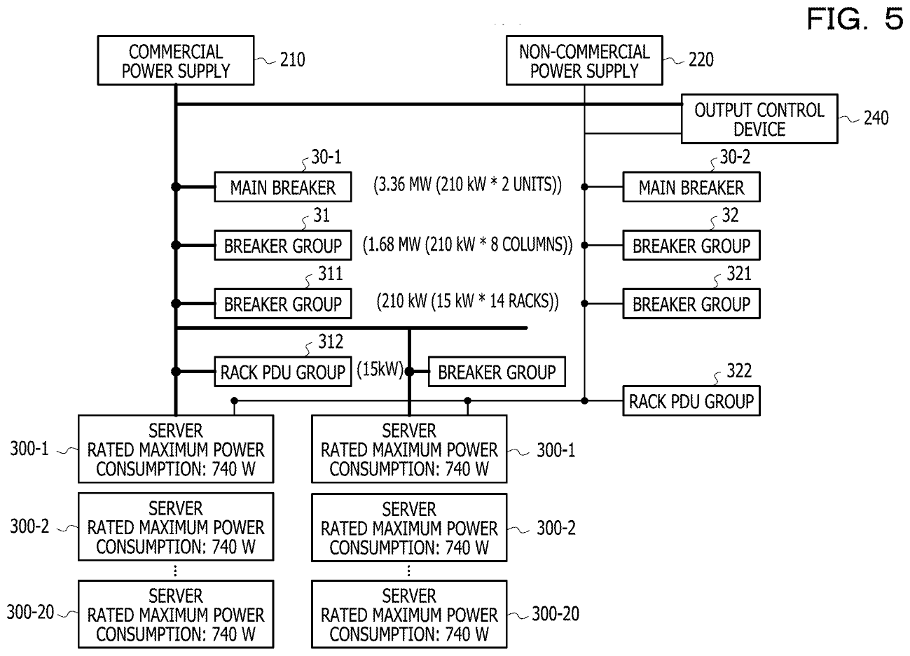

Next, with reference to FIG. 5, the estimation of the power consumption and the scales of the commercial power supply and the non-commercial power supply will be described in detail. FIG. 5 is a diagram describing estimation of the power consumption and scales of the commercial power supply and the non-commercial power supply.

In a case where the power consumption of the data center 200 is estimated, the power P1 that is the rated maximum power consumption of the server 300 is used as a reference. In the present embodiment, the power P1 that is the rated maximum power consumption of the server 300 is assumed to be 740 W.

In this case, power to be used in each rack PDU included in the rack PDU groups 312 and 322 in the fourth hierarchical level is 740 W×20=14.8 kW. It is assumed that power in each rack PDU is 15 kW in this case.

Each of the rack PDU groups 312 and 322 is coupled to each breaker included in each of the breaker groups 311 and 321 in the third hierarchical level. Accordingly, the power to be used in each breaker included in each of the breaker groups 311 and 321 is 15 kW×14=210 kW.

Each of the breaker groups 311 and 321 is coupled to each breaker included in the breaker groups 31 and 32 in the second hierarchical level. Accordingly, the power to be used in each breaker included in each of the breaker groups 31 and 32 is 210 kW×8=1.68 MW.

The breaker groups 31 and 32 are coupled to the main breakers 30-1 and 30-2 in the first hierarchical level, respectively. Accordingly, the power to be used in the main breakers 30-1 and 30-2 is 1.68 MW×2=3.36 MW.

For this reason, in the present embodiment, it is considered that the maximum rated powers of both the commercial power supply 210 and the non-commercial power supply 220 are set to about 3.4 MW when the scales of the commercial power supply 210 and the non-commercial power supply 220 are maximized.

Referring to the power distribution of the power consumption of the server 300 illustrated in FIG. 4, the actual power consumption of the server 300 is less than the power P5 indicating the median P3+3σ at a ratio of 99.7%.

For this reason, in the present embodiment, for example, the non-commercial power supply 220 may be capable of outputting power corresponding to the difference between the average power consumption and the actual maximum power consumption in the data center 200.

In the data center 200 of the present embodiment, the actual maximum power consumption is 2.4 MW, and the average power consumption is 1.5 MW. Accordingly, the non-commercial power supply 220 of the present embodiment may be set to 2.0 MW, which is substantially the same as a value obtained by subtracting 1.5 MW from 2.4 MW. For example, the non-commercial power supply 220 of the present embodiment may be a gas turbine generator or the like having a maximum output power of 2 MW.

In the present embodiment, the power consumption in the data center 200 and the scales of the commercial power supply 210 and the non-commercial power supply 220 are estimated in this manner. For example, the estimation is performed by an administrator or the like of the data center 200.

In the present embodiment, the predetermined time and the predetermined ratio used in the process of predicting an increase in power consumption may be determined in accordance with the upper limit value of the power to be supplied from the commercial power supply 210 and the maximum output of the non-commercial power supply 220.

For example, the predetermined time and the predetermined ratio are set in advance by the administrator or the like of the data center 200 such that an increase in power consumption is covered by the power supplied from the non-commercial power supply 220 while the power supplied from the commercial power supply 210 is maintained to be less than the upper limit value.

In the present embodiment, by setting the upper limit value (threshold) of the power to be supplied from the commercial power supply 210 based on the distribution of the power consumption based on the specifications, the number, and the like of the servers 300 constituting the data center 200, it is possible to set the scale of the non-commercial power supply 220 as a power supply having an appropriate scale.

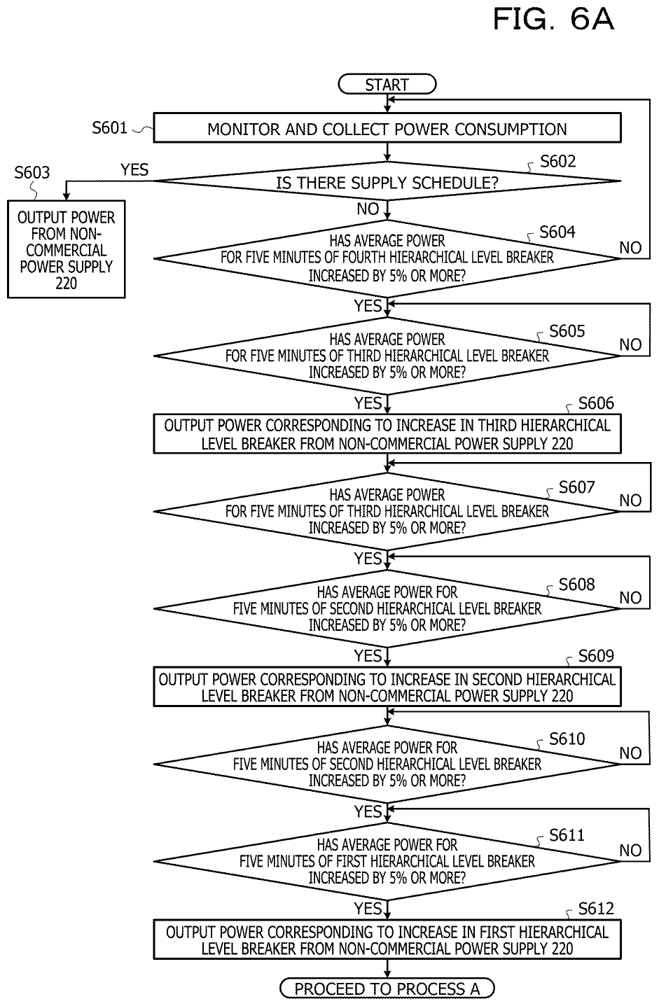

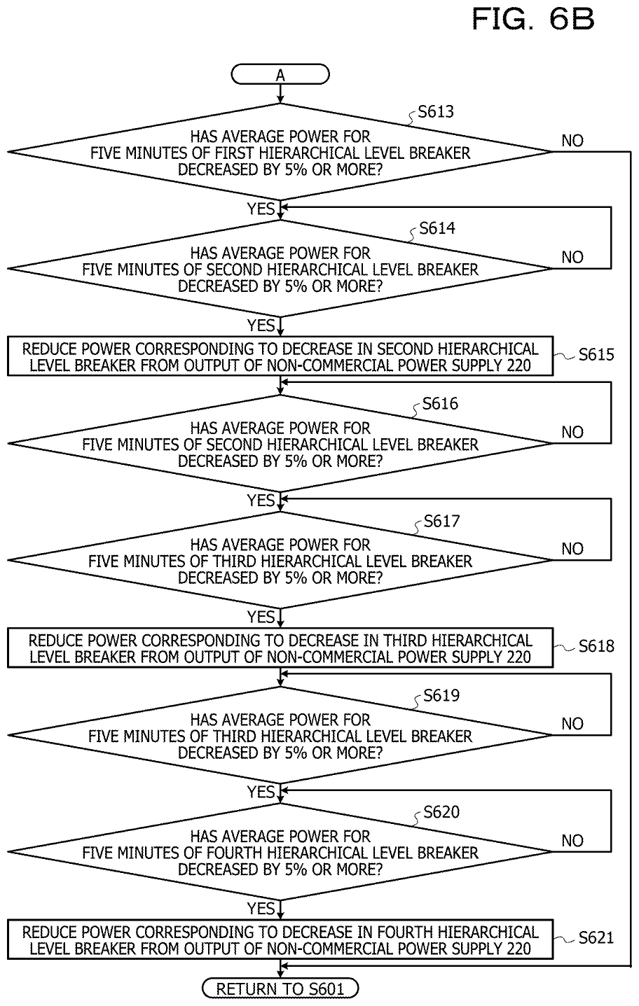

Hereinafter, the operation of the power control apparatus 100 of the present embodiment will be described with reference to FIGS. 6A and 6B. FIG. 6A is a first flowchart describing a process of the power control apparatus. FIG. 6B is a second flowchart describing the process of the power control apparatus. Examples of FIGS. 6A and 6B illustrate a case where the predetermined time is five minutes and the predetermined ratio is 5%.

By using the power monitoring unit 110, the power control apparatus 100 of the present embodiment collects the power values output from all the wattmeters 40 and monitors the power of each breaker (operation S601).

After that, the power control apparatus 100 determines whether or not there is a schedule in which supplying power from the non-commercial power supply 220 is determined (operation S602). In a case where there is a determined schedule in operation S602, the power control apparatus 100 causes the output instruction unit 150 to instruct the output control device 240 to output the determined power from the non-commercial power supply 220 (operation S603).

In a case where there is no determined schedule in operation S602, the power control apparatus 100 causes the average value calculation unit 130 to calculate the average value of the power detected for five minutes for each fourth hierarchical level breaker. By using the determination unit 140, the power control apparatus 100 determines whether or not the average value of the power for five minutes has increased by 5% or more (operation S604).

In a case where the average value of the power for five minutes has not increased by 5% or more in operation S604, the power control apparatus 100 returns to operation S601.

In a case where the average value of the power for five minutes of a certain fourth hierarchical level breaker has increased by 5% or more in operation S604, the power control apparatus 100 causes the determination unit 140 to refer to the average value of the power for five minutes of the third hierarchical level breaker to which the certain fourth hierarchical level breaker is coupled. The determination unit 140 determines whether or not the average value of the power for five minutes of this third hierarchical level breaker has increased by 5% or more (operation S605).

In a case where the average value of the power for five minutes of the third hierarchical level breaker has not increased by 5% or more in operation S605, the power control apparatus 100 waits.

In a case where the average value of the power for five minutes of the third hierarchical level breaker has increased by 5% or more in operation S605, the power control apparatus 100 causes the non-commercial power supply 220 to output power corresponding to the increase in power of the third hierarchical level breaker (operation S606).

For example, the power control apparatus 100 causes the output instruction unit 150 to instruct the output control device 240 to output, from the non-commercial power supply 220, power obtained by adding the increase in power of the third hierarchical level breaker and the current output power.

For each third hierarchical level breaker, the power control apparatus 100 calculates the average value of power for five minutes. By using the determination unit 140, the power control apparatus 100 determines whether or not the average value of the power for five minutes has increased by 5% or more (operation S607).

In a case where the average value of the power for five minutes has not increased by 5% or more in operation S607, the power control apparatus 100 waits.

In a case where the average value of the power for five minutes of a certain third hierarchical level breaker has increased by 5% or more in operation S607, the power control apparatus 100 causes the determination unit 140 to refer to the average value of the power for five minutes of the second hierarchical level breaker to which the certain third hierarchical level breaker is coupled. The determination unit 140 determines whether or not the average value of the power for five minutes of this second hierarchical level breaker has increased by 5% or more (operation S608).

In a case where the average value of the power for five minutes of this second hierarchical level breaker has not increased by 5% or more in operation S608, the power control apparatus 100 waits.

In a case where the average value of the power for five minutes of this second hierarchical level breaker has increased by 5% or more in operation S608, the power control apparatus 100 causes the non-commercial power supply 220 to output power obtained by adding the increase in power of the second hierarchical level breaker (operation S609).

Next, for each second hierarchical level breaker, the power control apparatus 100 calculates the average value of power for five minutes. By using the determination unit 140, the power control apparatus 100 determines whether or not the average value of the power for five minutes has increased by 5% or more (operation S610).

In a case where the average value of the power for five minutes has not increased by 5% or more in operation S610, the power control apparatus 100 waits.

In a case where the average value of the power for five minutes of a certain second hierarchical level breaker has increased by 5% or more in operation S610, the power control apparatus 100 causes the determination unit 140 to refer to the average value of the power for five minutes of the first hierarchical level breaker to which the certain second hierarchical level breaker is coupled. The determination unit 140 determines whether or not the average value of the power for five minutes of this first hierarchical level breaker has increased by 5% or more (operation S611).

In a case where the average value of the power for five minutes of this first hierarchical level breaker has not increased by 5% or more in operation S611, the power control apparatus 100 waits.

In a case where the average value of the power for five minutes of this first hierarchical level breaker has increased by 5% or more in operation S611, the power control apparatus 100 causes the non-commercial power supply 220 to output power obtained by adding the increase in power of the first hierarchical level breaker (operation S612). The process then proceeds to a process A illustrated in FIG. 6B.

After operation S612, the power control apparatus 100 causes the average value calculation unit 130 to calculate the average value of the power for five minutes of each first hierarchical level breaker. By using the determination unit 140, the power control apparatus 100 determines whether or not the average value of the power for five minutes has decreased by 5% or more (operation S613).

In a case where the average value of the power for five minutes has not decreased by 5% or more in operation S613, the power control apparatus 100 returns to operation S601.

In a case where the average value of the power for five minutes of a certain first hierarchical level breaker has decreased by 5% or more in operation S613, the power control apparatus 100 causes the determination unit 140 to refer to the average value of the power for five minutes of the second hierarchical level breaker coupled to the certain first hierarchical level breaker. The determination unit 140 determines whether or not the average value of the power for five minutes of this second hierarchical level breaker has decreased by 5% or more (operation S614).

In a case where the average value of the power for five minutes of the second hierarchical level breaker has not decreased by 5% or more in operation S614, the power control apparatus 100 waits.

In a case where the average value of the power for five minutes of the second hierarchical level breaker has decreased by 5% or more in operation S614, the power control apparatus 100 causes the non-commercial power supply 220 to output power obtained by subtracting the decrease in power of the second hierarchical level breaker from the current output power (operation S615). For example, the power control apparatus 100 reduces the power output from the non-commercial power supply 220 by an amount corresponding to the decrease in power of the second hierarchical level breaker.

Next, for each second hierarchical level breaker, the power control apparatus 100 calculates the average value of power for five minutes. By using the determination unit 140, the power control apparatus 100 determines whether or not the average value of the power for five minutes has decreased by 5% or more (operation S616).

In a case where the average value of the power for five minutes has not decreased by 5% or more in operation S616, the power control apparatus 100 waits.

In a case where the average value of the power for five minutes of a certain second hierarchical level breaker has decreased by 5% or more in operation S616, the power control apparatus 100 causes the determination unit 140 to refer to the average value of the power for five minutes of the third hierarchical level breaker coupled to the certain second hierarchical level breaker. The determination unit 140 determines whether or not the average value of the power for five minutes of this third hierarchical level breaker has decreased by 5% or more (operation S617).

In a case where the average value of the power for five minutes of this third hierarchical level breaker has not decreased by 5% or more in operation S617, the power control apparatus 100 waits.

In a case where the average value of the power for five minutes of this third hierarchical level breaker has decreased by 5% or more in operation S617, the power control apparatus 100 causes the non-commercial power supply 220 to output power obtained by subtracting the decrease in power of the third hierarchical level breaker from the current output power (operation S618). For example, the power control apparatus 100 reduces the power output from the non-commercial power supply 220 by an amount corresponding to the decrease in power of the third hierarchical level breaker.

For each third hierarchical level breaker, the power control apparatus 100 calculates the average value of power for five minutes. By using the determination unit 140, the power control apparatus 100 determines whether or not the average value of the power for five minutes has decreased by 5% or more (operation S619).

In a case where the average value of the power for five minutes has not decreased by 5% or more in operation S619, the power control apparatus 100 waits.

In a case where the average value of the power for five minutes of a certain third hierarchical level breaker has decreased by 5% or more in operation S619, the power control apparatus 100 causes the determination unit 140 to refer to the average value of the power for five minutes of the fourth hierarchical level breaker coupled to the certain third hierarchical level breaker. The determination unit 140 determines whether or not the average value of the power for five minutes of this fourth hierarchical level breaker has decreased by 5% or more (operation S620).

In a case where the average value of the power for five minutes of this fourth hierarchical level breaker has not decreased by 5% or more in operation S620, the power control apparatus 100 waits.

In a case where the average value of the power for five minutes of this fourth hierarchical level breaker has decreased by 5% or more in operation S620, the power control apparatus 100 causes the non-commercial power supply 220 to output power obtained by subtracting the decrease in power of the fourth hierarchical level breaker from the current output power (operation S621). The process then returns to operation S601. For example, the power control apparatus 100 reduces the power output from the non-commercial power supply 220 by an amount corresponding to the decrease in power of the fourth hierarchical level breaker. The process then returns to operation S601.

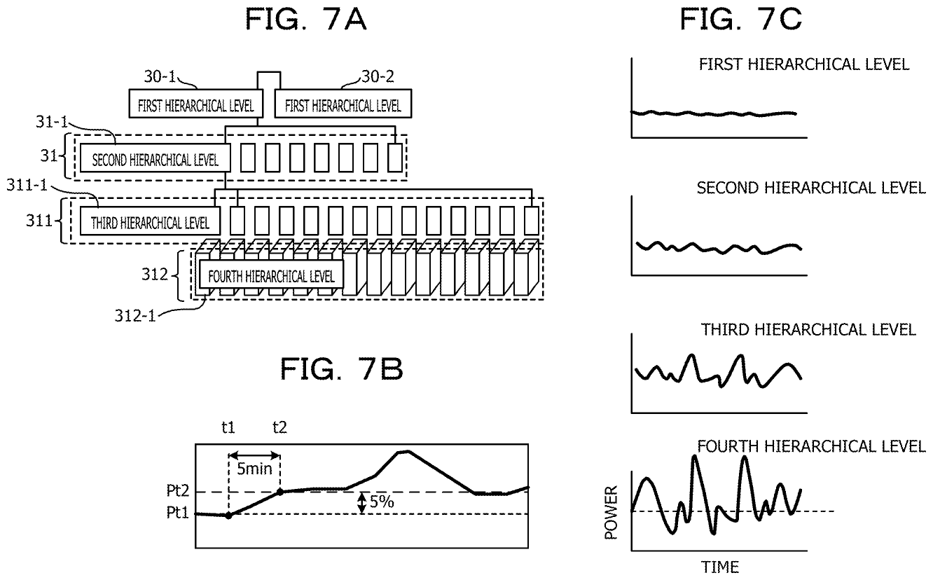

Hereinafter, the process of the power control apparatus 100 will be described in detail with reference to FIGS. 7A to 7C. FIGS. 7A to 7C are diagrams describing the process of the power control apparatus.

FIG. 7A is a diagram illustrating a relationship of the breakers in the respective hierarchical levels. FIG. 7B is a diagram for describing a change in power. FIG. 7C is a diagram illustrating an example of a change in power of the breakers in the respective hierarchical levels.

For all the breakers in the first to fourth hierarchical levels, the power control apparatus 100 of the present embodiment calculates the average value of the power detected by the wattmeters 40 every five minutes. The power control apparatus 100 determines whether or not the average value of the power for five minutes of each breaker has increased by 5% or more compared with the average value calculated five minutes ago.

For example, it is assumed that, among the rack PDUs 312 included in the fourth hierarchical level breaker group illustrated in FIG. 7A, the average value of the power for five minutes of the rack PDU 312-1 has increased by 5% or more. A fluctuation in the average value of the power of the rack PDU 312-1 will be described below with reference to FIG. 7B.

FIG. 7B illustrates a fluctuation in the average value of the power of the rack PDU 312-1 every five minutes. In FIG. 7B, the average value of the power of the rack PDU 312-1 at time t is Pt1. In FIG. 7B, an average value Pt2 at time t2, which is a time five minutes after the time t1, has increased by 5% or more from the average value Pt1 at the time t1.

In this case, the power control apparatus 100 determines whether or not there is a breaker of which the average value of the power has increased by 5% or more, among the fourteen breakers included in the third hierarchical level breaker group 311 to which the rack PDU 312-1 is coupled.

It is assumed that the average value of the power of the breaker 311-1 among the fourteen breakers included in the third hierarchical level breaker group 311 has increased by 5%. In this case, the power control apparatus 100 increases the power output from the non-commercial power supply 220 by an amount increased in the breaker 311-1.

In the same manner, the power control apparatus 100 determines whether or not there is a breaker of which the average value of the power has increased by 5% or more, among the eight breakers included in the second hierarchical level breaker group 31 to which the breaker 311-1 is coupled.

In a case where there is a breaker of which the average value of the power has increased by 5% or more in the second hierarchical level breaker group 31, the power control apparatus 100 increases the power output from the non-commercial power supply 220 by an amount increased in the second hierarchical level breaker group 31.

In the present embodiment, as described above, the presence or absence of a breaker of which the average value of the power has increased by a predetermined ratio or more is detected from the breaker group in the lowermost hierarchical level among the breaker groups in the plurality of hierarchical levels. Subsequently, in a case where the average value of the power of even one breaker has increased by a predetermined ratio or more in the breaker group in the lowermost hierarchical level, the same process is performed on a hierarchical level immediately above the lowermost hierarchical level. In a case where there is a breaker of which the average value has increased by a predetermined ratio or more also in the immediately above hierarchical level, it is regarded that the power consumption of the data center 200 tends to increase and the non-commercial power supply 220 is caused to output the power obtained by adding the increase in power in the immediately above hierarchical level to current output power.

In the present embodiment, by sequentially performing the process from the lowermost hierarchical level in this manner, it is possible to reduce the fluctuation in the average value of the power as the hierarchical level becomes higher.

FIG. 7C illustrates a fluctuation in the average value of the power detected from the breakers in each hierarchical level at predetermined time intervals. The average value of the power of the fourth hierarchical level breaker is a value in which the fluctuation in power consumption of the server 300 coupled to the fourth hierarchical level breaker is directly reflected.

In the example of FIG. 7C, the fluctuation in the average value of the power of the fourth hierarchical level breaker is the largest, and the fluctuation in the average value of the power of the third hierarchical level breaker is smaller than the fluctuation in the average value of the power of the fourth hierarchical level breaker. The fluctuation in the average value of the power of the second hierarchical level breaker is smaller than the fluctuation in the average value of the power of the third hierarchical level breaker, and the average value of the power of the main breaker 30-1 which is the first hierarchical level breaker hardly fluctuates.

For example, the influence of the fluctuation in the power consumption of the server 300 on the power supplied from the commercial power supply 210 to the first hierarchical level breaker is suppressed, and the power supplied from the commercial power supply 210 to the first hierarchical level breaker is maintained in a state of being less than the upper limit value held in the threshold holding unit 120.

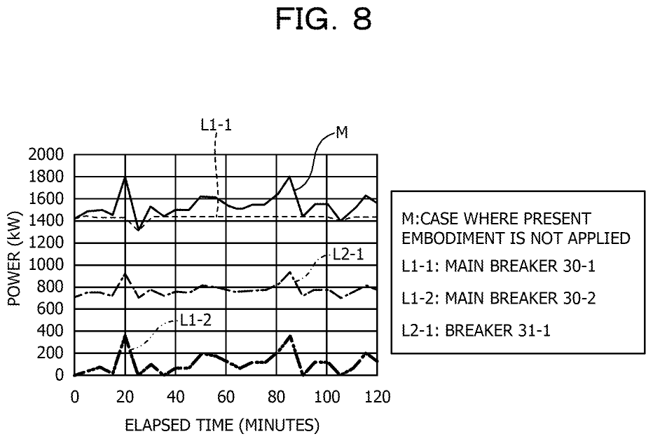

Next, an effect of the present embodiment will be described with reference to FIG. 8. FIG. 8 is a diagram describing an effect of the present embodiment.

In FIG. 8, a vertical axis indicates power, and a horizontal axis indicates an elapsed time. In FIG. 8, a polygonal line M indicates power supplied from the commercial power supply 210 in a case where the present embodiment is not applied, and a polygonal line L1-1 indicates power detected from the main breaker 30-1 of the present embodiment. For example, the polygonal line L1-1 indicates power supplied from the commercial power supply 210 in the present embodiment.

A polygonal line L1-2 indicates power detected from the main breaker 30-2 of the present embodiment. For example, the polygonal line L1-2 indicates power supplied from the non-commercial power supply 220 in the present embodiment. A polygonal line L2-1 indicates power detected from the breaker 31-1 that is the second hierarchical level breaker in the present embodiment.

FIG. 8 illustrates a case where the average power consumption of the data center 200 is 1.5 MW and the upper limit value of the power supplied from the commercial power supply 210 is set to this average power consumption of 1.5 MW.

In this case, in FIG. 8, the power of the main breaker 30-2 indicated by the polygonal line L1-2 fluctuates in association with the fluctuation in power of the second hierarchical level breaker indicated by the polygonal line 12-1. While the polygonal line M largely fluctuates, the polygonal line L1-1 fluctuates slightly and does not exceed the upper limit value of 1.5 MW.

As described above, in the present embodiment, power is detected from the breaker in the lowermost hierarchical level in which an increase in power consumption of the server 300 is reflected. In the present embodiment, in a case where there is a breaker of which the average value of the power has increased by a predetermined ratio or more in the plurality of hierarchical levels, the output of the non-commercial power supply 220 is adjusted in accordance with this increase.

According to the present embodiment, it is possible to suppress the influence of an increase in power consumption of the server 300 on the power supplied from the commercial power supply 210. For this reason, it is possible to maintain the power supplied from the commercial power supply 210 to be less than the set upper limit value, and to keep the power consumption from exceeding the contract demand of the commercial power supply 210.

In the present embodiment, in the plurality of hierarchical levels, the presence or absence of a breaker of which the average value of the power has decreased by a predetermined ratio or more is detected sequentially from the breaker in the uppermost hierarchical level. In a case where there is a breaker of which the average value of the power has decreased by a predetermined ratio or more in a certain hierarchical level and a hierarchical level below the certain hierarchical level, the power supplied from the non-commercial power supply 220 is decreased by an amount of decrease in the hierarchical level below the certain hierarchical level.

In the present embodiment, as described above, it is possible to reduce the load of the non-commercial power supply 220 by adjusting the power supplied from the non-commercial power supply 220 in accordance with the decrease in power consumption of the data center 200. In the present embodiment, since the presence or absence of a breaker of which the average value of the power has decreased by a predetermined ratio or more is detected sequentially from the uppermost hierarchical level in which the influence of the power consumption of the server is most unlikely to be reflected, it is possible to suppress a shortage of the supply of the power from the non-commercial power supply 220.

The present disclosure is not limited to the specifically disclosed embodiments, and various modifications and changes may be made.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing a control program for causing a computer to execute a process, the process comprising:
detecting, at predetermined time intervals, an average value of power detected from each breaker of breaker groups in a plurality of hierarchical levels to which power is supplied from a plurality of power supplies; and
causing, in a case where there is a breaker of which the average value has an increase by a predetermined ratio or more in a certain hierarchical level and an upper hierarchical level of the certain hierarchical level among the plurality of hierarchical levels, one power supply among the plurality of power supplies to output power obtained by adding the increase in the breaker in the upper hierarchical level.

2. The non-transitory computer-readable recording medium according to claim 1, the process further comprising:
detecting presence or absence of the breaker of which the average value has the increase by the predetermined ratio or more sequentially from the breaker group in a lowermost hierarchical level among the plurality of hierarchical levels; and
detecting, in a case where there is the breaker of which the average value has the increase by the predetermined ratio or more in the breaker group in a lower hierarchical level among the plurality of hierarchical levels, presence or absence of the breaker of which the average value has the increase by the predetermined ratio or more in the breaker group in a hierarchical level immediately upper of the lower hierarchical level.

3. The non-transitory computer-readable recording medium according to claim 1, the process further comprising:
causing, in a case where there is the breaker of which the average value has a decrease by the predetermined ratio or more in the certain hierarchical level and a lower hierarchical level of the certain hierarchical level among the plurality of hierarchical levels, the one power supply to output power obtained by subtracting the decrease in the breaker in the lower hierarchical level.

4. The non-transitory computer-readable recording medium according to claim 3, the process further comprising:
detecting presence or absence of the breaker of which the average value has the decrease by the predetermined ratio or more sequentially from the breaker group in an uppermost hierarchical level among the plurality of hierarchical levels; and
detecting, in a case where there is the breaker of which the average value has the decrease by the predetermined ratio or more in the breaker group in an upper hierarchical level among the plurality of hierarchical levels, presence or absence of the breaker of which the average value has the decrease by the predetermined ratio or more in the breaker group in a hierarchical level immediately lower of the upper hierarchical level.

5. The non-transitory computer-readable recording medium according to claim 1,
wherein the plurality of power supplies are a commercial power supply and a non-commercial power supply, and the one power supply is the non-commercial power supply.

6. A control method for causing a computer to execute a process, the process comprising:
detecting, at predetermined time intervals, an average value of power detected from each breaker of breaker groups in a plurality of hierarchical levels to which power is supplied from a plurality of power supplies; and
causing, in a case where there is a breaker of which the average value has an increase by a predetermined ratio or more in a certain hierarchical level and an upper hierarchical level of the certain hierarchical level among the plurality of hierarchical levels, one power supply among the plurality of power supplies to output power obtained by adding the increase in the breaker in the upper hierarchical level.

7. A control method for causing a computer to execute a process, the process comprising:
detecting, at predetermined time intervals, an average value of power detected from each breaker of breaker groups in a plurality of hierarchical levels to which power is supplied from a plurality of power supplies; and
causing, in a case where there is a breaker of which the average value has a fluctuation by a predetermined ratio or more in a certain hierarchical level and an upper or lower hierarchical level of the certain hierarchical level among the plurality of hierarchical levels, one power supply among the plurality of power supplies to output power based on the fluctuation in the breaker in the upper or lower hierarchical level.
